(19) United States
(12) Patent Application Publication
(10) Pub. No.: US 2004/0125933 A1
(43) Pub. Date: Jul. 1, 2004

(54) Managing and initiating conference calls

(76) Inventors: Peng Jun, Shejiang (CN); Meng Lingjun, Zhejiang (CN); Justin Mallen, San Francisco, CA (US); Chen Yu, Zhejiang (CN)

Correspondence Address: FISH & RICHARDSON P.C., 5000 BANK ONE CENTER, 1717 MAIN STREET, DALLAS, TX, 75201, US

(21) Appl. No.: 10/422,446

(22) Filed: Apr. 23, 2003

(30) Foreign Application Priority Data
Dec. 31, 2002 (CN) 02160717.6
Mar. 19, 2003 (CN) 03115878.1

(51) Int. Cl. H04M 3/42; H04M 7/00

(52) U.S. Cl. 379/202.01; 379/229

(57) ABSTRACT

Systems and techniques are provided for supporting multi-party meetings over a telecommunication network. In one implementation, meeting status information may be provided to a client for display on a user interface. The meeting may involve a voice connection between the parties that is established over a Signaling System 7 (SS7) network. Status change information may be received over the SS7 network, and the status change information may be forwarded to the client for updating the user interface display. Other implementations may involve receiving a meeting group identifier via a signaling network and retrieving routing numbers associated with the meeting group identifier. Calls can be initiated using each of the routing numbers, and the calls may be connected together to establish a conference call.

### CROSS REFERENCE TO RELATED APPLICATION

This application claims the benefit of priority from Chinese Patent Application No. 02160717.6, entitled “A Multi-Party Communication System”, filed Dec. 31, 2002, and Chinese Patent Application No. 03115878.1, entitled “A One-Time Access Approach of a Multi-Party Meeting System”, filed Mar. 19, 2003, the disclosures of which are incorporated by reference.

### TECHNICAL FIELD

This invention relates to conference call systems, and more particularly to allowing users of a conference call system to conveniently and efficiently manage the conference call process.

### BACKGROUND

Conference call systems facilitate communications among groups of participants. In particular, participants located at a variety of remote locations can communicate using a telephone or other type of communication network. Conference calls can be used for virtually any type of communications, such as conducting business, making social plans, coordinating activities, organizing events, and the like. In addition, use of a conference call system can help eliminate the travel time and expense required to meet face-to-face and allows an entire group to communicate at the same time, instead of requiring multiple calls between individual pairs of group members.

Typical conference call systems require the use of a third party operator to set up a conference call. For example, a conference call chairperson might contact a conference call service provider one or more days in advance of a planned conference call to set up a conference call. The conference call chairperson provides each of the participants with a specific telephone number associated with the service provider. Around the time the conference call is scheduled to begin, each call participant calls in to a specific telephone number and asks to be connected to the conference call or enters a code assigned to the conference call. This type of system, however, requires advance planning and does not allow the conference call chairperson to conveniently manage and control the conference call.

### SUMMARY

Techniques are provided for managing multi-party conference calls. Conference calls can be set up by defining meeting groups using a client-server web interface. Each meeting group may include a number of group members, each of which has an associated routing or phone number. Users may establish a conference call by accessing an application server either via a client device or by calling in from a mobile or wireline phone and identifying a meeting group. The application server may then call each of the group members and establish a conference call, which can be remotely managed either through a user interface on a client device or from a phone. The calls to each group member may be established via a signaling network, and status information for each group member may be received via the signaling network. Status information may be updated on the user interface, which may include a visual representation of the ongoing conference call. In some implementations, a conference call may be initiated by “one-button” dialing from a phone that results in sending a meeting group identifier appended to an access number over the signaling network to the conference call system.

In one general aspect, a multi-party meeting system includes an application server and a hardware server. The application server controls a meeting between multiple parties and provides meeting status information to a client device for display on a user interface. The meeting may be conducted over one or more telecommunication networks. The hardware server receives control information from the application server and establishes a voice connection between the parties in response to the control information. The hardware server may also receive status information for each party from a Signaling System 7 (SS7) network and may forward the status information to the application server. The application server may then provide the status information to the client device for updating the user interface display.

Implementations may include one or more of the following features. For example, the status information received from the SS7 network may represent a connection status for each party or a speech status for each party. The application server may operate to initiate the meeting in response to a request received from the user interface of the client device or in response to a request received through the SS7 network from a telephone. The request may include an identifier associated with the meeting. The system may also include a database for storing meeting identifiers. Each meeting identifier may be associated with a specific set of parties. The hardware server may establish the voice connection between the parties by initiating a call to a telephone number associated with each of the parties. The application server may also be operable to send text messages to the plurality of parties. The application server may control the meeting between the parties based on commands received from the user interface of the client.

In another general aspect, a multi-party conference call may be initiated by receiving a meeting group identifier via a signaling network and retrieving a list of routing numbers associated with the meeting group identifier. In response to the received meeting group identifier, a call may be initiated using each of the routing numbers in the list, and the calls may be connected together to establish a conference call.

Implementations may include one or more of the following features. For example, the signaling network may be a Signaling System 7 network. The meeting group identifier may be appended to an access number associated with a conference call system. The meeting group identifier appended to the access number may be sent in response to an activation of a single button on a mobile station. Call status information may be received for each call via the signaling network. The routing number may be a phone number.

The meeting group identifier may be assigned to a meeting group that has selected members, each of which has an associated routing number. The meeting group identifier may be stored in association with the routing numbers for each member. The request to establish the conference call may be received at a server from a user interface displayed on a client or may be received at a server via a Signaling System 7 network. Initiating the conference call may involve calling each of the members via the Signaling System 7 network, and status information for each call may be received via the Signaling System 7 network. The members in the meeting group may be initially defined using a user interface on a client device. The meeting group identifier and the associated routing numbers for each member may be stored in a database associated with a remote server. The conference call may be initiated from the remote server in response to a request to establish the conference call, which may be received through a TCP/IP network from a client device or through a signaling network from a mobile station.

In another general aspect, a machine-readable medium may store instructions that are operable to cause one or more machines to perform certain operations. The operations may include displaying a visual representation of a conference room that corresponds to a conference call involving multiple parties and receiving a status change indication for one or more parties to the conference call. The visual representation may be updated in response to the status change indication.

Implementations may include one or more of the following features. For example, the visual representation may include a number of human images, which each represent a party to the conference call. Updating the visual representation may involve altering one of the human images. The change in status may include a change in connection status, a change in speaking status, and/or a change in speech authorization. Selected conference call members may be associated with the conference call, and the visual representation may include an image of an empty chair for each conference call members that is not connected to the conference call. The visual representation may be displayed on a user interface, and a request may be received via the user interface to initiate the conference call. In addition, commands for controlling the conference call may also be received via the user interface. An indication of a change in speech authorization for one or more of the parties may be received via the user interface.

The details of one or more implementations are set forth in the accompanying drawings and the description below. Other features will be apparent from the description and drawings, and from the claims.

### DESCRIPTION OF DRAWINGS

FIG. 1 is a flow diagram of a process for managing conference calls.

FIG. 2 is a block diagram of a conference call management system.

FIG. 3 is a flow diagram of a process for conducting a conference call.

FIG. 4 is an illustrative diagram of an overall call conferencing system.

FIG. 5 is an example of an online conference management view for a user interface.

FIG. 6 is an example of an address book management view.

FIG. 7 is an example of a meeting room creation view.

FIG. 8 is an example of a meeting management view.

FIG. 9 is an example of a meeting management view for a meeting that is in-progress.

FIG. 10 is a block diagram of a conventional mobile conference call system.

Like reference symbols in the various drawings indicate like elements.

### DETAILED DESCRIPTION

Systems and techniques may be implemented to conveniently set up and manage conference calls. The systems and techniques may be used not only in the typical telephone-based conference call scenario but also in connection with video conferencing, conferencing via a short message service, and other types of multi-party communications. The systems and techniques may involve setting up a conference call using a web-based application in which call participants can be selected and assigned to a particular meeting group. The conference call setup process may involve entering a telephone number for each participant and establishing other parameters for conference calls involving the meeting group. The conference call could then be initiated either from a client device (e.g., using an application that contacts a central server) or from a wireless or wireline phone (e.g., by dialing an 800 number and entering a code associated with the meeting group) by automatically dialing out to each of the participants.

The systems and techniques may be implemented by integrating a wireless network with certain exchange and management functions in an IP-based environment to provide an easy to use platform for the initiation, monitoring, and management of multi-person calls. Although such a system may be implemented in connection with a wireless network, access to the system may be available through fixed line and wireless Internet connections, short message service (SMS), and fixed line telecommunications systems.

The systems and techniques have a wide variety of applications, such as in the public security sector for case checking, in the transportation sector for traffic control, in field facility setup and repair for handling emergencies, and for conducting mobile office work or for interactive or urgent meetings. For instance, the systems and techniques may be applied in place of a municipal “walkie-talkie” system. Deploying a “walkie-talkie” system requires a tremendous initial capital outlay as well as maintenance fees. In addition, different vendors may use different frequencies, which may prevent one system from being used in different geographical areas. There are also a number of security and privacy issues when using “walkie-talkie” systems over public frequencies because such systems do not allow for control over access to the communications. By using the systems and techniques described here, a wireless conference call system may be used in place of a “walkie-talkie” system based on existing wireless communication infrastructures (e.g., GSM). The system would not require a special channel and would not be bounded by regional restrictions.

The systems and techniques may also be used for personal communications. By providing for preset conference call groups, users can customize a list of friends and/or family members who can be easily accessed by initiating a conference call. The systems and techniques may also be used to allow users to call in to a meeting that is already in session. For example, a television station might host a talk show in which callers can call in to a group line and participate in the live show.

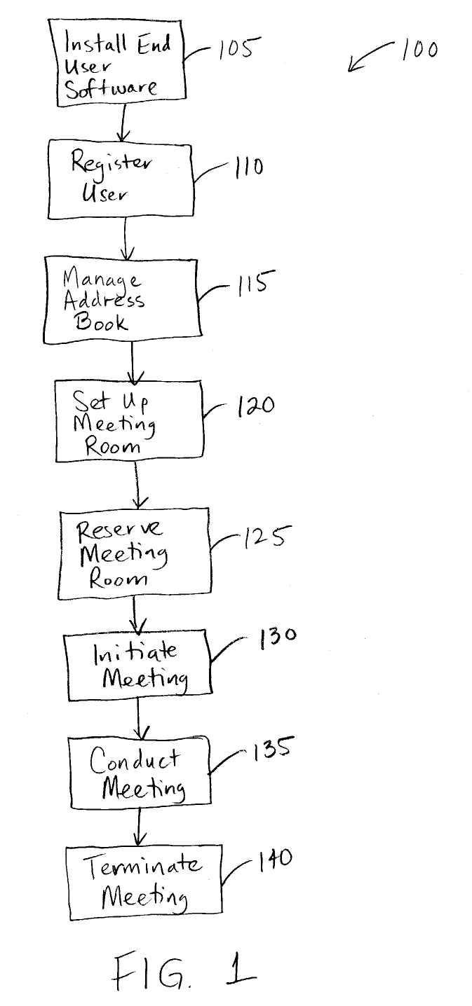

FIG. 1 is a flow diagram of a process 100 for managing conference calls. Initially, end user software is installed on a user's client device (step 105). The client device may comprise, for example, a personal computer or a personal digital assistant (PDA). The software may provide the user with the tools and interfaces needed to build and manage an address book, to create meeting groups, and to initiate, manage, and monitor conference calls involving the meeting groups. The software may be installed on the client device over an IP-based (or WAP-based) connection to a central application server.

The user then registers with the conference call system (step 110). The registration process may be conducted online and may involve selecting a user name and password, entering a mobile phone number and email address, and providing other contact, identification, billing, and/or demographic information. The user may also manage an address book (step 115). The address book may be maintained by the end user software, in a central application server, or in a separate software application on the client device. The address book may be organized by groups or departments and may include a variety of members. Managing the address book may include adding a group, adding a member, deleting a group, deleting a member, and modifying member information. For each member, the address book will generally include a name, one or more phone numbers, and possibly an email address.

The user may use the end user software to set up a virtual meeting room (step 120). The virtual meeting room represents a meeting group that may be used for group communications, such as conference calls and group SMS messages. The meeting room may be assigned a number or other identifier and may include members that are selected from the address book or that are entered manually. Other parameters, such as a maximum number of attendees, which phone number to call for each member, and an attendee password, may also be selected during meeting room setup. The user may also perform other meeting room management functions, such as modifying a meeting room (e.g., to add or delete members, to modify the parameters, to modify member information, and the like) or deleting a meeting room.

Once a meeting room is set up, the meeting room can be reserved for a particular time (step 125). The reservation may be used for an administrative or secretarial purposes (e.g., to provide a reminder of the scheduled meeting, to make sure that the members are available, and to prevent others from trying to reserve the same or an overlapping meeting room for the same time) and/or for resource management purposes (e.g., to ensure that enough system resources are available to support the conference call at the planned time).

The user can also initiate a meeting (step 130). The user may initiate a meeting using a pre-established meeting room that may or may not have been reserved in advance. Specific members of the meeting room may be included in or excluded from the meeting, and other members may be selected from the address book or entered manually for inclusion in the meeting. The user may also initiate a meeting that does not correspond to a pre-established meeting room by selecting members from the address book and/or entering members manually. The meeting may be initiated from a client device (e.g., by selecting a meeting room from a menu and selecting an option to initiate a meeting) or from a mobile or fixed line telephone (e.g., by dialing a designated telephone number plus a meeting room number and password).

In connection with initiating a meeting, or in connection with setting up a meeting room, the user may select an initial speech authorization for the attendee members. The speech authorization may be roundtable discussion, competition for microphone, chairperson selects speaker, or listen only. The user may also select certain meeting parameters, such as the meeting venue and automatic repeated call. The meeting venue may be used for purposes of identifying a location (e.g., a city) from which the calls are made for purposes of determining whether each call is subject to roaming or long distance charges. The automatic repeated call parameter may identify a number of times that a meeting attendee should be redialed if the first call attempt fails.

Once the meeting attendees are connected, the meeting is conducted (step 135). The meeting may be monitored through the end user software on the client device, regardless of whether the meeting is initiated from the client device. Depending on the authorizations given to each member, the meeting may be monitored by a meeting chairperson, one or more meeting members, and/or a meeting administrator. During the meeting, the status of each attendee may be displayed through a user interface supported by the end user software. For example, the user interface may indicate which attendees are currently connected, which attendee is currently speaking, which attendees have been disconnected (e.g., because they have left a service area, have experienced a dropped call, or have hung up), and which meeting members are unavailable (e.g., because they did not answer the original call or any redials). If desired, unavailable or disconnected members may be redialed automatically or by selecting an option on the user interface. In addition, meeting members may dial in to an in-progress meeting. Authorization to join the meeting may be based on a password, whether the member is on the attendee list (e.g., if there is a match between the member's caller ID number and the member information for the meeting room), and/or authorization by a meeting chairperson or administrator through the user interface. A meeting chairperson or administrator may also specifically disconnect and/or delete an attendee through the user interface.

During the meeting, the speech authorization for each member or for the entire meeting room may be changed through the user interface. For example, a meeting chairperson might change the status to a competition for microphone mode in which members are placed in a queue in response to member requests to talk and are selected from the queue based on some priority criteria. The meeting chairperson might change the status to a chairperson selection mode in which the chairperson selects the speaker. The chairperson might also hold a meeting within a meeting in which certain meeting members may be excluded from the conversation and from status information displayed on their respective user interfaces. Other modes may also be available, such as roundtable, in which all members are allowed to speak; listen only, in which selected meeting members are muted; and all listen, in which the chairperson is the only member allowed to speak. For each speech mode, corresponding changes to the user interface may be made to indicate the current mode and the current speaker.

The meeting management functions that may be performed from a client device using a user interface may also be performed using DTMF tones if, for example, the meeting is initiated from a phone rather than from a client device. As mentioned above, the meeting may be initiated, or joined by an attendee, from a mobile or fixed line phone. In addition, the chairperson might be able to switch speech modes using predefined DTMF tones. Other functions, such as disconnecting an attendee or redialing a meeting member, may also be performed using DTMF tones.

The meeting may be terminated (step 140) once the meeting is complete. The meeting chairperson or administrator may terminate the meeting through an option button on the user interface. Alternatively, the meeting may terminate once all of the members hang up. If only one member is left, the meeting may terminate after a predetermined amount of time (e.g., one minute). The meeting may automatically terminate when a scheduled ending time is reached, in which case a warning may be provided in advance of the termination. In some cases, the meeting chairperson or administrator may be able to request that the meeting be extended beyond a scheduled ending time.

Meetings are generally conducted using a voice connection but may also be conducted using SMS messaging. For example, an SMS message may be sent to all of the meeting members or to selected meeting members from a user interface of the end user software. In addition, an SMS message may be sent from a mobile phone by including a meeting room identifier and a password, if necessary, with the SMS address information or the SMS text. Such SMS messages could be used to conduct a text message meeting (i.e., similar to a chat room), to send text messages during a voice-based conference call, and/or for purposes of notifying members of an upcoming voice-based meeting.

Different users may have different roles in the conference call management process. For example, users may be assigned the role of administrator, chairperson, or attendee for one or more meeting rooms. An administrator may handle primarily administrative functions, such as managing address books, managing meeting rooms, scheduling meetings, monitoring a meeting, and controlling the inclusion of call-in attendees. The meeting chairperson may handle the actual meeting management in terms of the speech mode, which members are disconnected, and when the meeting terminates. Attendees may be given a more limited range of capabilities that may depend on the authorizations given by the chairperson and/or the administrator. In some cases, users may operate in more than one role.

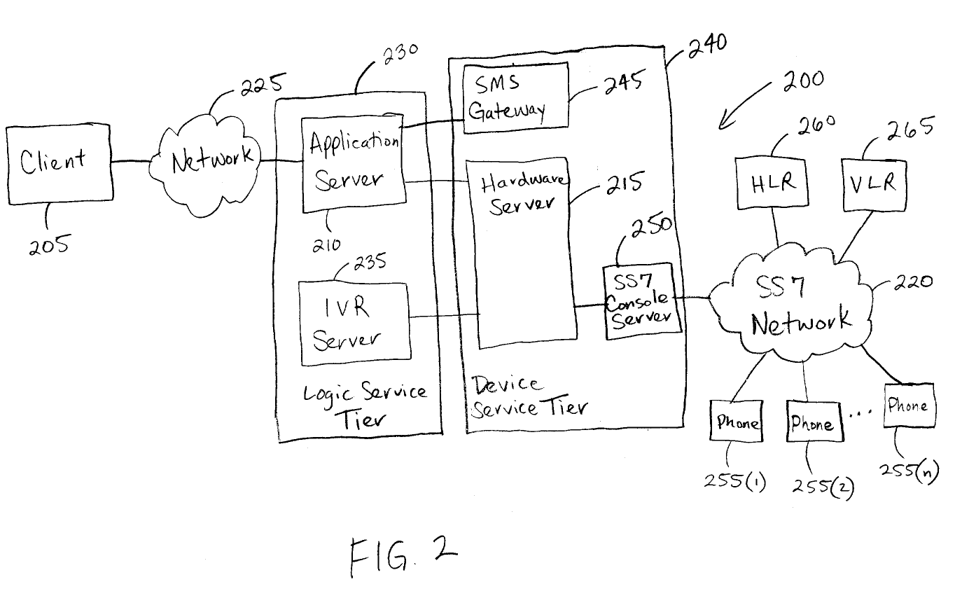

FIG. 2 is a block diagram of a conference call management system 200. The conference call management system 200 includes a logic service tier 230 and a device service tier 240 that are connected to a Signaling System 7 (SS7) signaling network 220. The device service tier 240 includes a hardware server 215 that interfaces with the SS7 network 220 through an SS7 console (or control) server 250 and a SS7 gateway (not shown). The device service tier 240 also includes an SMS gateway 245 that interfaces with a telecommunication network (not shown) for providing SMS services. The logic service tier 230 includes an application server 210 and an interactive voice response (IVR) server 235. The application server 210 connects to a client 205 through a network 225, such as the Internet. Although only one client 205 is illustrated, the application server may connect to virtually any number of clients 205. The system 200 may connect to various mobile or wireline phones 255(1)-255(n) through the SS7 network 220. The various components in the logic service tier 230 and device service tier 240 may communicate using socket mode communications, which makes the system flexible and easily scalable and allows for easy integration with other components. Moreover, each module can function as an independent service for other systems to use.

The application server 210 is the logic server of the system 200 and is in charge of meeting room management, meeting management, address book management, billing, SMS messages, and other system functions. For example, the application server 210 may be accessed by the client 205 so that a user can create or modify address books and meeting rooms and can initiate meetings from a user interface on the client 205. Users may thus send orders from end user software or through a browser on the client 205 to the application server 210 to conduct operations in a meeting room. The application server 210 may also be accessed by a mobile or wireline phone 255 to perform meeting setup and management functions. The application server 210 thus operates to support the functions illustrated in and described in connection with FIG. 1.

When meeting setup and control functions are conducted from a phone 255 (e.g., in DTMF format), however, the commands received through the SS7 network 220 are routed by the hardware server 215 to the IVR server 235 for interpretation. Once interpreted, the functions are carried out by the application server 210. In some implementations, to initiate a meeting from a phone, a single button may be used. Activating the button may result in dialing of a meeting room identifier (and password, if necessary) appended to an access number for the conference call management system 200. The aggregated number may be sent via the SS7 network to the hardware server 215, which, in association with the IVR server 235 and the application server 210 may establish a conference call among the members of the identified meeting room. Thus, a one-button conference call capability may be implemented.

In one possible implementation, for example, the one-button conference call capability may be used in a family connected cell phone for use by children. The child may have a one or more button cell phone. One button, when pressed, may automatically call the parents, possibly another caretaker (e.g., a nanny), and/or another relative (e.g., a grandmother). Thus, activation of the button initiates a call to a special access number, which may result in establishing a conference call among family members or some other specified group. The conference call members who are called may be based on a predefined association between the members and the special access number, in which case the special access number is assigned to one conference call group. Alternatively, to be able to re-use the special access number for multiple different conference call groups, the conference call members who are called may be determined by a meeting room identifier appended to the special access number (i.e., with the special access number and the appended meeting room identifier stored in the phone and associated with the button) or may be determined based on a predefined association between the members and the calling party number (e.g., the caller ID number for the child's cell phone). The child then has an “emergency” lifeline at one push of a button, and parents and other caretakers have a better way to keep track of their child. Another button may be an “emergency” button of sorts in that it sends out an SMS message to the cellular service provider, and the service provider can triangulate the position of the child and locate them. Similarly, the one-button conference call capability may be used for quickly establishing a conference call among friends/family circles.

In performing logical functions, the application server 210 will frequently need to initiate hardware control functions, which are generally performed by the hardware server 215. The application server 210 sends orders to the hardware server 215 responsible for resource distribution. The application server 210 may also communicate with the SMS gateway 245 to send SMS messages. In general, the hardware server 215 controls resources in response to orders received from the application server 210 and sends related orders to the SS7 console server 250. When a conference call is to be initiated, the hardware server 215 operates to call the meeting members via the SS7 console server 250 using numbers provided by the application server 210. In addition, the hardware server 215 provides the necessary switching to connect a number of lines together to form a conference. The hardware server 215 may control a voice card and a conference card. The voice card may be used for setting up and receiving calls and may also provide the IVR functions. The conference card may be used for providing conferencing capabilities (i.e., for providing a voice connection between various different calls).

The SS7 console server 250 is in charge of the operation and control of SS7 signaling for the conference call management system 200 on the SS7 network 220. The SS7 console server 250 interprets route information and addresses received over the SS7 network 220 and submits the route information and addresses to the hardware server 215, which may further pass the data to the application server 210. More particularly, the SS7 console server 250 may conduct a layer-by-layer analysis and treatment on digital information received from the SS7 network 220. In this manner, the application server 210 can, for example, determine which attendees are currently connected and/or speaking and can control a user interface of the client 205 to reflect the current status by displaying telephone line status information. The SS7 console server 250 also receives orders from the hardware server 215 to connect a phone 255, processes the orders, and sends related orders to the SS7 network 220.

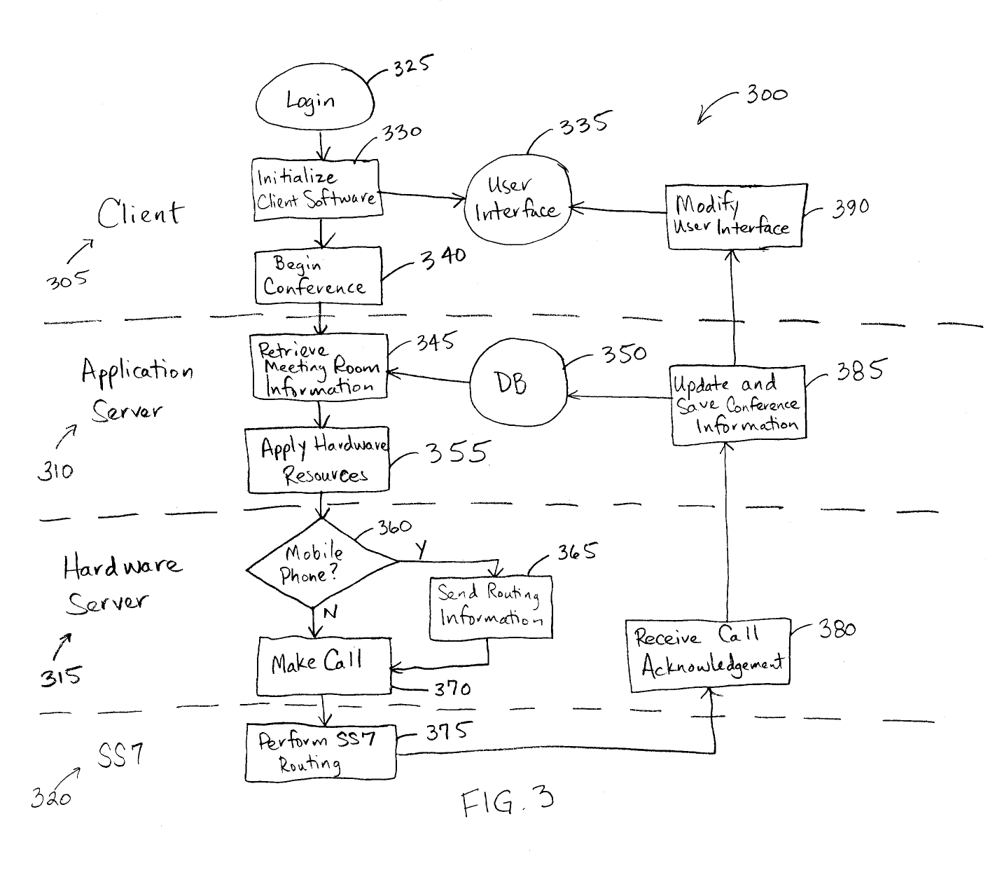

FIG. 3 is a flow diagram of a process 300 for conducting a conference call. Different steps of the process may be carried out by different components, such as a client 305, an application server 310, a hardware server 315, and an SS7 layer 320. Initially, a user may login to a conference call management system (step 325), which may result in an initialization of client software (step 330) on a client device 305. Initializing the client software may be conducted through a TCP/IP connection with the application server 310 and may involve registration and authentication processing. Once the client software is initialized, a user interface 335 is displayed on the client 305. The user interface 335 generally provides the user with a variety of options, including address book or meeting room management, meeting initiation and control, and the like. The user may select an option to begin a conference for a selected meeting room (step 340).

In response, the application server 310 may retrieve the meeting room information (step 345), such as the phone numbers for the meeting members, for the selected meeting room from a database 350. Based on the retrieved information, the application server 310 applies the hardware resources (step 355) by sending an appropriate order to the hardware server 315. The hardware server 315 determines if each attendee phone number represents a mobile phone (step 360). If so, the routing information is sent (step 365) for purposes of making a call to the mobile phone (step 370). If the requested resource is not a mobile phone but a wireline phone, mobile routing information is not necessary, and a call is made (step 370).

Appropriate SS7 routing is performed for each call (step 375), and for each call, a call acknowledgement is sent back over the SS7 network 320 (step 380) to the hardware server 315 to indicate whether the call was successful or not. The conference information is updated and stored (step 385) in the database 350 based on the call acknowledgement information. Appropriate information is also sent by the application server 310 to the client 305 to modify the user interface 335 (step 390) to reflect the current conference status information.

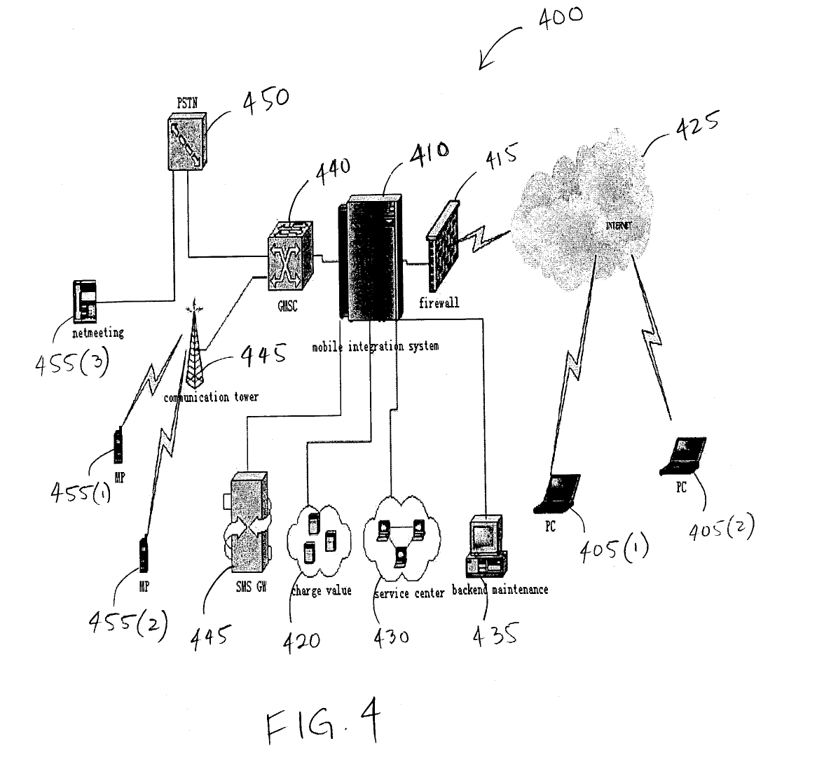

FIG. 4 is an illustrative diagram of an overall call conferencing system 400. The call conferencing system 400 includes a mobile integration system 410 that essentially corresponds to the logic service tier 230 and the device service tier 240 of FIG. 2. Thus, the mobile integration system 410 controls the application services, including meeting room and address book management, meeting management, SMS messaging, and the like, performs hardware control, and interfaces with a signaling network. Other components may be connected to the mobile integration system 410 to support additional functions. An SMS gateway 445 may connect the system to an SMS network, a set of charge value servers 420 may be used for maintaining billing information, a service center 430 may allow for operator control of the mobile integration system 410, and a backend maintenance console 435 may facilitate maintenance of the system 410.

Client devices 405, such as PCs, may connect to the mobile integration system 410 via the Internet 425 through a firewall 415 to access the application services provided by the system 410. Mobile phones 455(1) and 455(2) may also connect to the mobile integration system 410 through a communication tower 445 (e.g., a base station) and a gateway mobile switching center (GMSC) 440. Similarly, a wireline phone 455(3) may connect to the mobile integration system 410 through a public switched telephone network (PSTN) 450, which connects to the GMSC 440. The mobile and wireline phones 455 may be used to access the application services and also may be called by the mobile integration system 410 for purposes of conducting a conference call. The mobile phones 455(1) and 455(2) may also receive SMS messages sent via the SMS gateway 445.

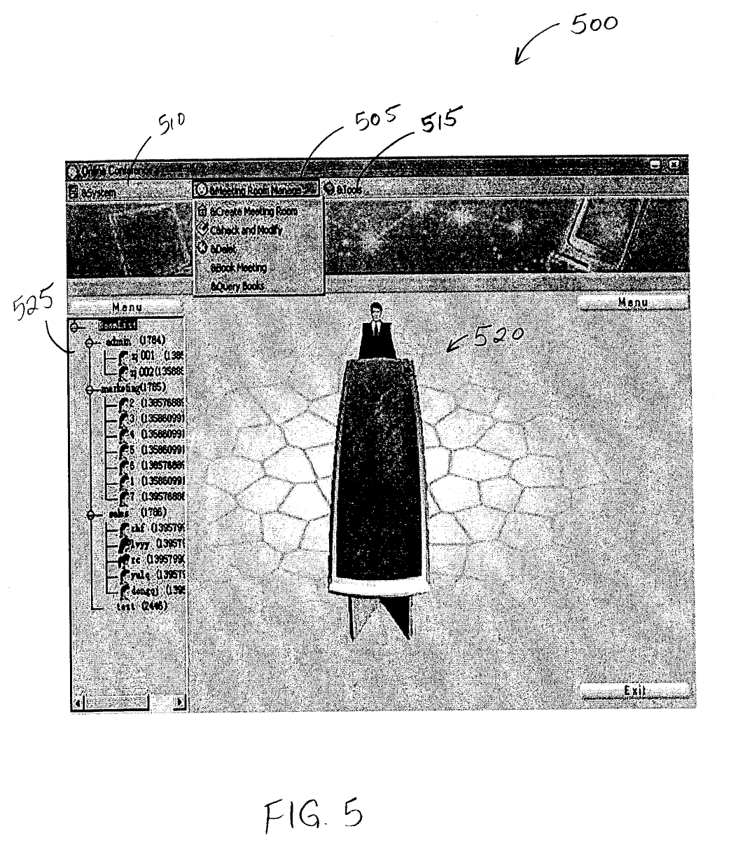

FIG. 5 is an example of an online conference management view 500. The online conference management view 500 includes a meeting room management menu 505 from which a user can select options to create a meeting room, view and edit a meeting room, delete a meeting room, schedule a meeting, and search one or more address books. Other options may be available in the meeting room management menu 505, in a system menu 510, or in a tools menu 515. For example, the tools menu 515 may include options to create and manage an address book and to manage billing information. The online conference management view 500 also includes a visual representation 520 of a conference room for displaying conference status information. A meeting room menu tree 525 lists the meeting rooms for a particular user and may, for each meeting room, include a list of members.

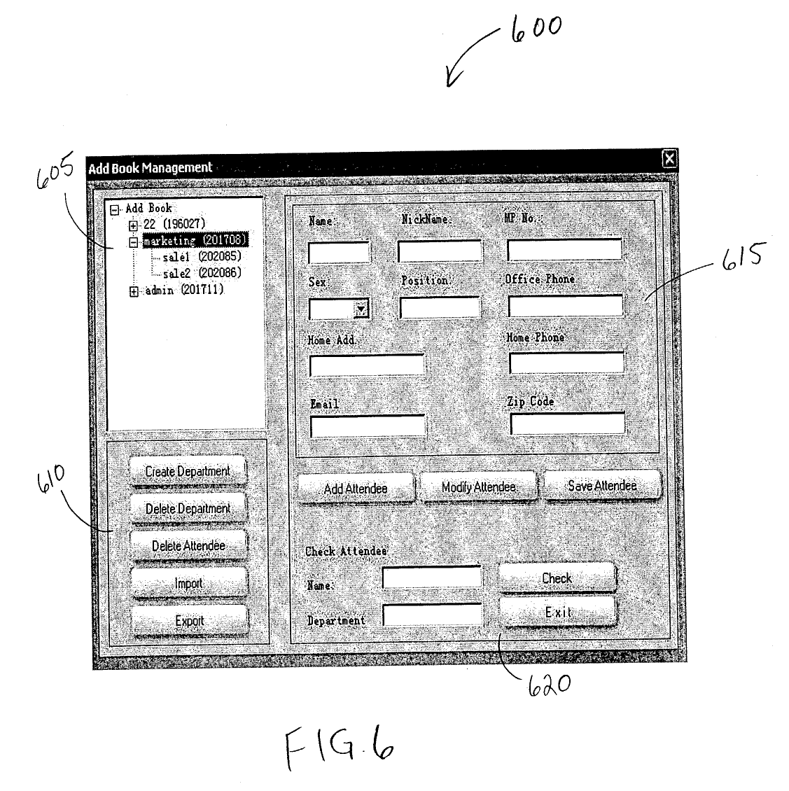

FIG. 6 is an example of an address book management view 600. The address book management view 600 includes a contact list menu tree 605, which may be organized in a hierarchy by departments or groups, sub-groups, and individuals. The address book management view 600 may also include option buttons 610 for creating a new department, deleting a department, deleting an individual, importing members or groups from other address books, and exporting members or groups to other address books. In the illustrated embodiment, the address book is maintained for purposes of supporting the conference call system, so individuals are identified as attendees. A data entry area 615 may be used for adding and modifying attendees, and a check attendee area 620 may be used to search for attendees in the address book.

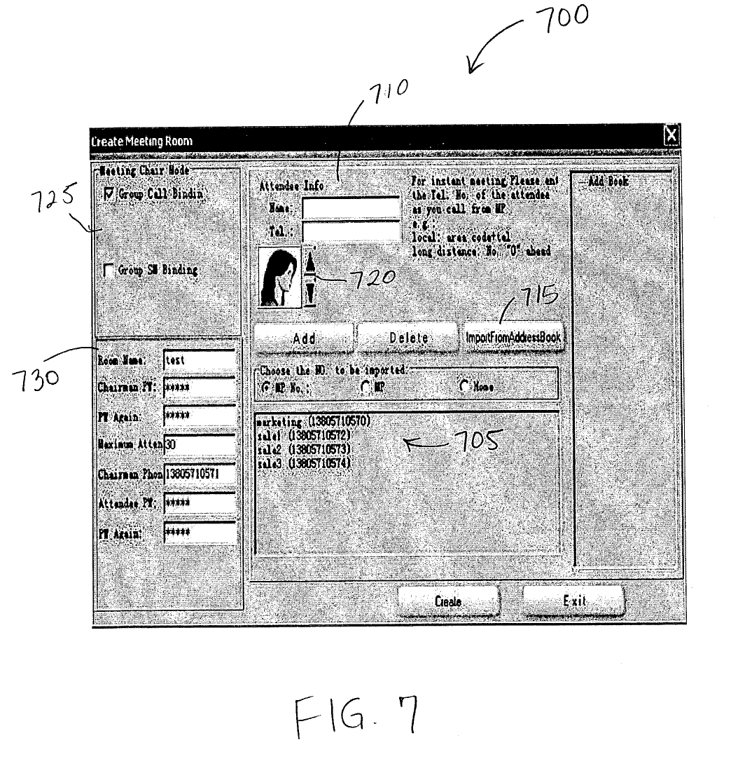

FIG. 7 is an example of a meeting room creation view 700. The meeting room creation view 700 may be used to generate a list 705 of attendees and their corresponding contact information (i.e., mobile or wireline phone numbers) for a particular meeting room and to configure certain options for the meeting room. Attendee information can be entered manually using an attendee information entry area 710 or may be imported from an address book using an import button 715. The user may also use an image selection menu 720 to select an image for representing each attendee in the visual display of the meeting room. A meeting chair mode option view 725 may be used to control whether a meeting for the meeting room can be initiated from a phone or whether a meeting must be initiated from the conference call application, to indicate who can initiate a meeting (e.g., an administrator, the meeting chairperson, and/or attendees), and to indicate who is permitted to send SMS messages to the meeting room. Additional option fields 730 may allow for entry of a meeting room name, a chairperson password, a maximum number of attendees, the chairperson's phone number, and an attendee password.

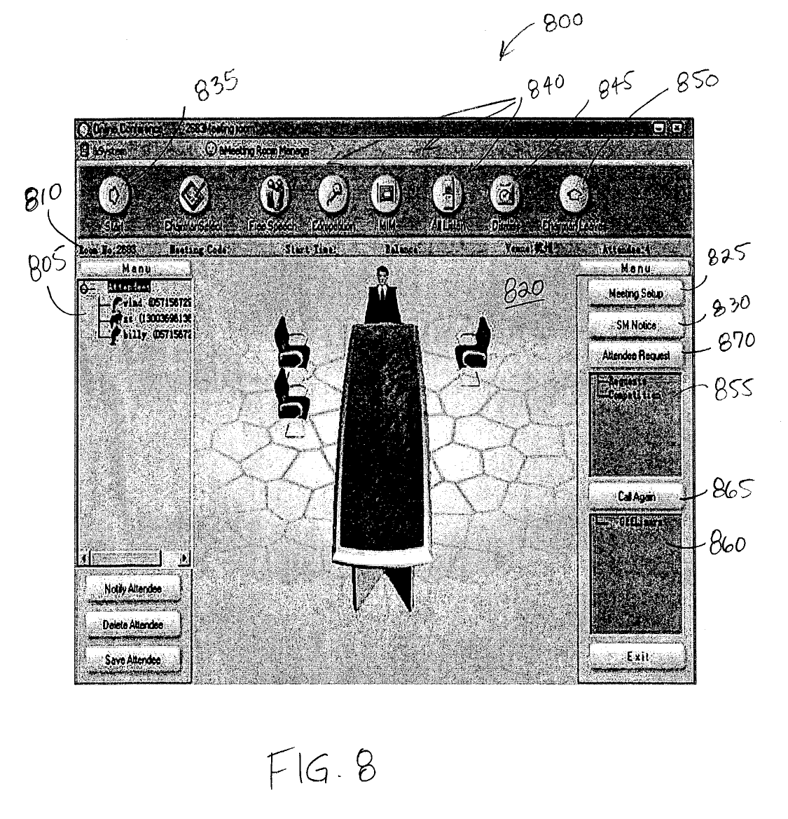

FIG. 8 is an example of a meeting management view 800. The meeting management view 800 includes an attendee list 805 and a meeting information bar 810 that may display meeting information, such as the meeting room number, a meeting code, a scheduled start time, a balance for billing purposes, a venue for the meeting, and a number of attendees. The status of the meeting is represented in a visual representation 820 of a conference room. Empty chairs in the visual display represent attendees who are not currently connected. A meeting setup button 825 may be used for configuring meeting options and a short message button 830 may be used for sending a short message to the attendees. A start button 835 may be used to initiate a conference call, and a number of speech mode selection buttons 840 may be used by the chairperson or by an administrator to control the speech mode during a conference call. A dismiss button 845 may be used to terminate the conference call, and a chairperson leaves button 850 may allow the chairperson to be disconnected from the conference call while allowing the meeting to continue among the remaining attendees. A speech mode status window 855 may display information regarding attendee requests to speak and competition for microphone requests. Attendees may submit requests using an attendee request button 870. Attendees who are not connected may be displayed in an offline status window 860. The chairperson or administrator may opt to redial such attendees using a call again button 865.

Different options may be displayed on the meeting management view 800 depending on the role of the user that is accessing the view 800. For example, the speech mode selection buttons 840 may not be displayed on an attendee's user interface. Alternatively, unavailable options may be indicated by shading or dimming the corresponding buttons.

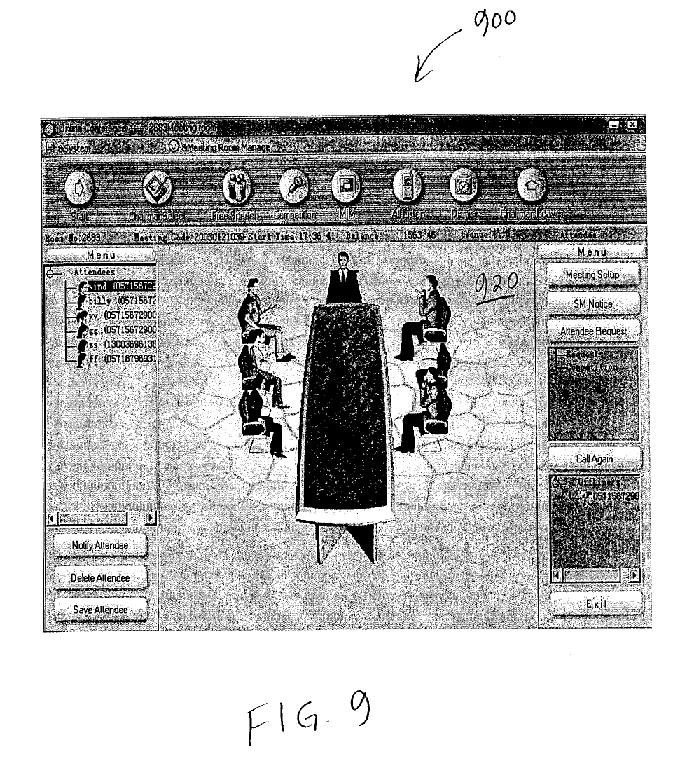

FIG. 9 is an example of a meeting management view 900 similar to that of FIG. 8 but with a meeting in progress. Meeting attendees that are currently connected are represented in the visual representation 920 of a conference room by images seated in chairs. Each attendee may be represented by a different image to more easily distinguish among the attendees. Highlighting or otherwise altering the image that corresponds to the speaker may identify the current speaker. Attendees that are authorized to speak may be displayed in color, while attendees who are currently not authorized to speak (e.g., because they are in listen only mode) may be displayed in black and white, shaded, or dimmed.

In some implementations, the conference call management system 200 adopts the Mobile Application Part (MAP) and ISDN (Integrated Services Digital Network) User Part (ISUP) protocols for the SS7 communications. In addition, the system, through the device service tier 240, for example, provides an independent communication port. These aspects of the system 200 allow the hardware server 215 to screen reminder signals from the local telecommunications switch (or port office) during a multi-party conference call and allow for more customized billing solutions.

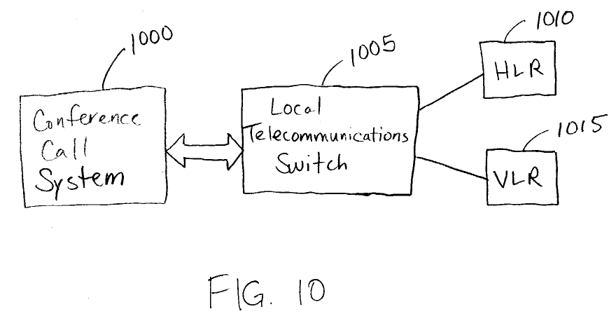

FIG. 10 illustrates a conventional mobile conference call system 1000. In this type of system 1000, the local telecommunications switch 1005 retrieves information about the participants, such as their locations, from a home location register (HLR) 1010 and/or visitor location register (VLR) 1015 in response to call orders received from the conference call system 1000. The local telecommunications switch 1005 then initiates calling or broadcasts reminder signals to the participants based on the information received from the HLR 1010 and/or VLR 1015. After the initial call is placed, the received information is used to decide whether the reminder signals are to be broadcast.

In the conference call management system 200 described here, however, the SS7 console server 250 represents a port office that retrieves location information directly from the HLR 260 and/or VLR 265 (through the SS7 signaling network 220). Information from the HLR 1010 and VLR 1015, which is retrieved using the MAP protocol, allows the system to determine whether each participant is roaming, among other things. The SS7 console server 250 sends the retrieved information to the hardware server 215. The hardware server 215 then decides whether to continue calling and connect each participant to the meeting room. This configuration allows the hardware server 215 to screen out many unnecessary reminder signals to reduce the load on the overall system.

By using the MAP protocol information, the system 200 can determine if the mobile phone belonging to one of the participants is in a roaming status. When the system 200 initiates the calls to the various participants, the system 200 is able to determine whether each participant is in the local area or whether the call is a direct distance dialing (DDD) or international direct distance dialing (IDDD) call. The system 200 can then handle billing for the use of the conference calling service, separate and apart from the mobile network billing. Thus, the billing can be customized by the conference call system provider.

A number of implementations have been described. Nevertheless, it will be understood that various modifications may be made. For example, functions may be performed by different components than those indicated in FIGS. 2 and 3, and signaling networks other than SS7 may be used for routing call information. The logic flows depicted in FIGS. 1 and 3 do not require the particular order shown, or sequential order, to achieve desirable results. In addition, certain functions, such as reserving a meeting room, may be omitted. Accordingly, other embodiments are within the scope of the following claims.

What is claimed is:

1. A multi-party meeting system, the system comprising:
an application server for controlling a meeting between a plurality of parties and for providing meeting status information to a client for display on a user interface, wherein the meeting is conducted over at least one telecommunication network;
a hardware server for receiving control information from the application server and for establishing a voice connection between the plurality of parties in response to the control information, wherein the hardware server receives status information for each of the parties from a Signaling System 7 (SS7) network and forwards the status information to the application server; and
wherein the application server provides the status information received by the hardware server to the client for updating the user interface display.

2. The system of claim 1 wherein the status information received from the SS7 network comprises a connection status for each party.

3. The system of claim 1 wherein the status information received from the SS7 network comprises a speech status for each party.

4. The system of claim 1 wherein the application server operates to initiate the meeting in response to a request received from the user interface of the client.

5. The system of claim 1 wherein the application server operates to initiate the meeting in response to a request received through the SS7 network from a telephone, with the request including an identifier associated with the meeting.

6. The system of claim 1 further comprising a database for storing a plurality of meeting identifiers, with each meeting identifier associated with a specific set of parties, wherein the meeting controlled by the application server corresponds to one of the meeting identifiers.

7. The system of claim 1 wherein the hardware server establishes the voice connection between the plurality of parties by initiating a call to a telephone number associated with each of the parties.

8. The system of claim 1 wherein location information for at least one of the parties is obtained using mobile application part protocol signaling.

9. The system of claim 1 wherein the application server is operable to send text messages to the plurality of parties.

10. The system of claim 1 wherein the application server controls the meeting between the plurality of parties in response to commands received from the user interface of the client.

11. A method for initiating a multi-party conference call, the method comprising:
receiving a meeting group identifier via a signaling network;
retrieving a list of routing numbers associated with the meeting group identifier;
initiating a call using each of the routing numbers in the list in response to receiving the meeting group identifier; and
connecting the calls together to establish a conference call.

12. The method of claim 11 wherein the signaling network comprises a Signaling System 7 network.

13. The method of claim 11 wherein the meeting group identifier is appended to an access number associated with a conference call system.

14. The method of claim 13 wherein the meeting group identifier appended to the access number is sent in response to an activation of a single button on a mobile station.

15. The method of claim 11 further comprising receiving call status information for each call via the signaling network.

16. The method of claim 11 further comprising retrieving, from a location register, an indication of a roaming status for at least one of the calls.

17. The method of claim 11 wherein the routing number comprises a phone number.

18. A machine-readable medium storing instructions operable to cause one or more machines to perform operations comprising:
displaying a visual representation of a conference room, wherein the visual representation corresponds to a conference call involving a plurality of parties;
receiving an indication of a change in status for at least one party to the conference call; and
updating the visual representation in response to the status change indication.

19. The machine-readable medium of claim 18 wherein the visual representation includes a plurality of human images, with each human image representing a party to the conference call.

20. The machine-readable medium of claim 19 wherein updating the visual representation includes altering one of the human images, and the change in status comprises one of a change in connection status, a change in speaking status, and a change in speech authorization.

21. The machine-readable medium of claim 18 wherein selected conference call members are associated with the conference call and the visual representation includes an image of an empty chair for a conference call member that is not connected to the conference call.

22. The machine-readable medium of claim 18 wherein the visual representation is displayed on a user interface, the machine-readable medium further storing instructions operable to cause one or more machines to perform operations comprising:
receiving a request via the user interface to initiate the conference call; and
receiving commands for controlling the conference call via the user interface.

23. The machine-readable medium of claim 18 wherein the visual representation is displayed on a user interface, the machine-readable medium further storing instructions operable to cause one or more machines to perform operations comprising receiving, via the user interface, an indication of a change in speech authorization for at least one of the plurality of parties.

24. A method for facilitating multi-party conference calls, the method comprising:
identifying a plurality of members in a meeting group, with each member having an associated routing number;
assigning a meeting group identifier to the meeting group;
storing the meeting group identifier in association with the routing numbers for each member;
receiving a request to establish a conference call, wherein the request includes an identification of the meeting group identifier; and
initiating a conference call by calling each of the members in the meeting group using the routing numbers stored in association with the meeting group identifier.

25. The method of claim 24 wherein the routing numbers comprise phone numbers.

26. The method of claim 24 wherein the request to establish the conference call is received at a server from a user interface displayed on a client.

27. The method of claim 24 wherein the request to establish the conference call is received at a server via a Signaling System 7 network.

28. The method of claim 24 wherein initiating the conference call comprises calling each of the members via a Signaling System 7 network, the method further comprising receiving status information for each call via the Signaling System 7 network.

29. The method of claim 24 wherein identifying the plurality of members in the meeting group is performed using a user interface on a client device, the meeting group identifier in association with the routing numbers for each member is stored in a database associated with a remote server, and the conference call is initiated from the remote server in response to the request to establish the conference call.

30. The method of claim 29 wherein the request to establish the conference call is received through a TCP/IP network from a client device.

31. The method of claim 29 wherein the request to establish the conference call is received through a signaling network from a mobile station.

32. The method of claim 24 wherein receiving a request to establish a conference call is received in response to an activation of a single button on a phone.

33. The method of claim 32 wherein the meeting group identifier is selected from the group consisting of a special access phone number, an identifier appended to a special access phone number, and a calling party number associated with the request to establish a conference call.
